(19) United States
(12) Patent Application Publication
(10) Pub. No.: US 2023/0050349 A1
(43) Pub. Date: Feb. 16, 2023

(54) PLUG CONNECTOR WITH POSITIVE LOCKING MECHANISM

(71) Applicant: Amphenol Corporation, Wallingford, CT (US)

(72) Inventors: Bryan D. CULL, Anna, TX (US); Jon M. WOODRUFF, Allen, TX (US)

(21) Appl. No.: 17/975,845

(22) Filed: Oct. 28, 2022

Related U.S. Application Data
(62) Division of application No. 17/085,430, filed on Oct. 30, 2020.

(51) Int. Cl. G02B 6/38

(52) U.S. Cl. CPC G02B 6/3831; G02B 6/3881; G02B 6/3849; G02B 6/3818

(57) ABSTRACT

Systems and methods for a fiber optic connector with a positive locking mechanism are disclosed. The fiber optic connector has a plug connector and a mating receptacle connector. The plug connector is comprised of a plug body, a coupling lock indicator, an inner coupling nut, an outer coupling nut, a back shell, and a ferrule. The mating receptacle connector comprised of a rear cap, a receptacle body, a mating indicator, and a second ferrule. When the plug connector is fully mated to the mating receptacle connector, the coupling lock indicator on the plug connector and the mating indicator on the mating receptacle connector are not visible, signaling that the two connectors are fully mated, but not locked in place. When the plug connector and the mating receptacle connector are locked in place, the coupling lock indicator is visible and the mating indicator is not visible, signaling positive locking.

### CROSS REFERENCE TO RELATED APPLICATIONS

This application is a divisional application of U.S. patent application Ser. No. 17/085430, filed Oct. 30, 2020, which is incorporated by reference in its entirety herein.

### BACKGROUND

The disclosure relates to a fiber optic connector with a positive locking mechanism.

Optical fiber connectors typically exhibit superior operation when there is a stable connection that minimizes the mismatch of corresponding ends of optical fibers. Therefore, it is beneficial to maintain a high degree of concentricity of the optical fibers.

Optical connections with matching 8° angles at the mating face prevent the signal from reflecting up the fiber. This is critical in applications involving sensors or sensitive transmitters. Matching the angles between the mating connectors significantly affects optical performance. Proper positioning of the termini relative to the angled face requires the termini to be keyed to the connector, and the connectors to be keyed to each other. Due to manufacturing tolerances, minimizing the number of keyed interfaces reduces positional variation and improves optical performance.

Single channel connectors are typically used in controlled environments; therefore, they are not typically designed for harsh environments. High-vibration/shock environments require a coupling method that will not loosen over time. While multiple solutions exist, they typically require a secondary action to actuate the locking mechanism (i.e. a secondary jam nut, clamping screws, or tie-wire holes). During installation, locking mechanisms requiring secondary action are often forgotten or skipped. Ratcheting coupling systems are often used to eliminate the secondary action, but they rely on friction and are prone to loosening in more extreme shock and vibration applications.

As such, there is a need for a high-performance, angle polish connector that ensures proper matching of the mating fibers while also positively locking the connection together without the need for a secondary action.

### SUMMARY

Accordingly, the present disclosure may provide a connector comprised of two components: a plug connector and a mating receptacle connector. The plug connector is comprised of a plug body, a coupling lock indicator, an inner coupling nut, an outer coupling nut, a back shell, and a ferrule. The mating receptacle connector comprised of a rear cap, a receptacle body, a mating indicator, and a second ferrule. When the plug connector is fully mated to the mating receptacle connector, the coupling lock indicator on the plug connector and the mating indicator on the mating receptacle connector are not visible, signaling that the two connectors are fully mated, but not locked in place. When the plug connector and the mating receptacle connector are locked in place, the coupling lock indicator is visible and the mating indicator is not visible, signaling positive locking.

In certain embodiments, the inner coupling nut and the rear cap are attached to one another to mate the plug connector and the mating receptacle connector.

In yet other embodiments, the plug connector includes ball bearings, which are held in place in radial indentations by the outer coupling nut, and those ball bearings are used in the locking or release of plug connector to the mating receptacle connector, which is performed by pushing the outer coupling nut forward.

In yet other embodiments, the plug connector includes an external key that fits into a groove in the receptacle body of the mating receptacle connector, resulting in coarse alignment between the plug connector and the mating receptacle connector.

This summary is not intended to identify essential features of the claimed subject matter, nor is it intended for use in determining the scope of the claimed subject matter. It is to be understood that both the foregoing general description and the following detailed description are exemplary and are intended to provide an overview or framework to understand the nature and character of the disclosure.

### BRIEF DESCRIPTION OF THE DRAWINGS

The accompanying drawings are incorporated in and constitute a part of this specification. It is to be understood that the drawings illustrate only some examples of the disclosure and other examples or combinations of various examples that are not specifically illustrated in the figures may still fall within the scope of this disclosure. Examples will now be described with additional detail through the use of the drawings, in which:

FIG. 1 is an exploded view of the plug connector, in accordance with an embodiment of the disclosure;

FIG. 2 is an exploded view of the mating receptacle connector, in accordance with one example of the disclosure;

FIG. 3 is a side cross-sectional view of the plug connector and certain components of the mating receptacle connector;

FIG. 4 is a side cross-section view of the mating receptacle connector and certain components of the plug connector;

FIG. 5A is a diagram of the plug connector and the mating receptacle connector in an uncoupled orientation;

FIG. 5B is a diagram of the plug connector and the mating receptacle connector in a coupled, unlocked orientation;

FIG. 5C is a diagram of the plug connector and the mating receptacle connector in a coupled and locked orientation;

FIG. 5D is a partial cross-section of the mated connectors in the locked position;

FIG. 6A is a partial cross-section showing the plug connector in the locked position with one of the ball bearings locked in one of the indents; and

FIG. 6B is a partial cross-section showing the plug connector in the unlocked position with one of the ball bearings free of the indents;

FIG. 7A is a cross-sectional cutaway for the plug connector and the mating receptable showing the common groove and the fiber; and

FIG. 7B is a cross-sectional view of the plug connector and mating receptacle showing the relative angle between the ferrules.

### DETAILED DESCRIPTION OF THE EMBODIMENTS

In describing the illustrative, non-limiting embodiments illustrated in the drawings, specific terminology will be resorted to for the sake of clarity. However, the disclosure is not intended to be limited to the specific terms so selected, and it is to be understood that each specific term includes all technical equivalents that operate in similar manner to accomplish a similar purpose. Several embodiments are described for illustrative purposes, it being understood that the description and claims are not limited to the illustrated embodiments and other embodiments not specifically shown in the drawings may also be within the scope of this disclosure.

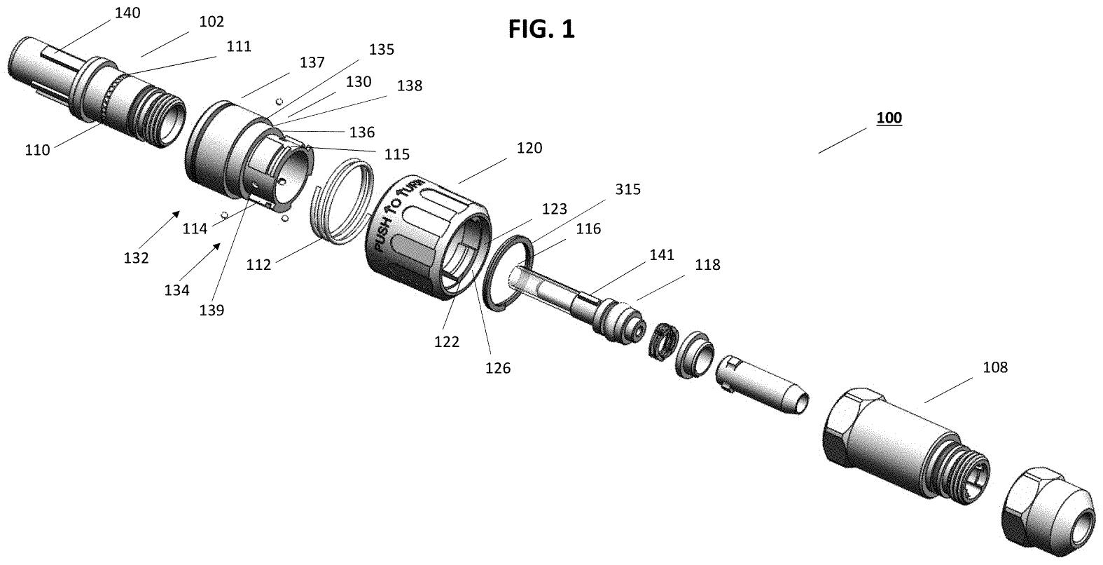

FIG. 1 is an exploded view of a plug connector 100, in accordance with an embodiment of the disclosure. The plug connector 100 has a plug body 102, coupling lock indicator 137, an inner coupling nut 130, an outer coupling nut 120, and a back shell 108. The plug body 102, inner coupling nut 130, outer coupling nut 120, and back shell 108 each have a circular transverse cross-section and a central opening or bore, and are configured to be coupled together to form the plug connector 100. The plug connector 100 has a central longitudinal axis.

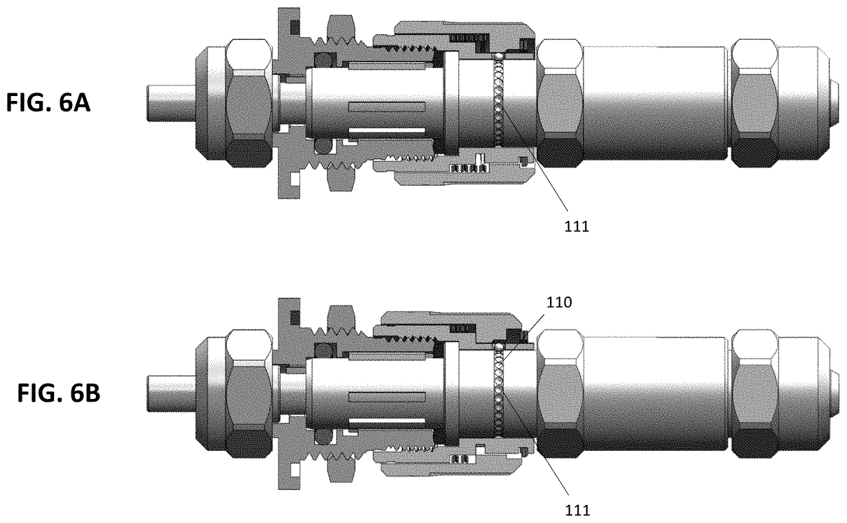

The plug body 102 is cylindrical in shape and elongated to form a tube and is configured to fit into and mate with the inner coupling nut 130. The plug body 102 has a forward end, a rearward end, a ridge formed where the forward end meets the rearward end, and an outer surface. The rearward end has a smooth section extending rearward from the ridge, and a threaded portion extending rearward from the smooth section. As shown in FIGS. 1, 6A, and 6B, a channel 111 extends radially about the outer surface completely around the outer diameter of the plug body 102 approximately midway along the smooth section of the outer surface at the rearward end of the plug body 102. A series of indents 110 are positioned at the bottom of the channel 111, each having a curved semi-spherical shape. The indents are arranged immediately adjacent to one another, so that each indent has an adjacent indent on two opposite sides to form a substantially continuous series of indents 110 that extend radially about the outer surface of the plug body 102.

The inner coupling nut 130 is cylindrical in shape and has an inner bore. The inner bore of the inner coupling nut 130 is larger than the plug body 102, so that the plug body 102 can be received in the inner bore of the inner coupling nut 130. The inner coupling nut 130 has an outer surface, a forward end 132, a rearward end 134, a first forward step 135, a second rearward step 136, and a ledge 138 between the first and second steps 135, 136. The steps 135, 136 and ledge 138 are at an intermediate portion of the inner coupling nut 130 between the forward end 132 and the rearward end 134. The outer diameter of the forward end 132 is larger than the outer diameter of the rearward end 134, forming the steps 135, 136 therebetween. A spring 112 is received on the ledge 138 and presses against the vertical face of the forward step 135.

The coupling lock indicator 137 is located on the outer surface of the inner coupling nut 130 at the forward end 132 of the inner coupling nut 130 and close to the forwardmost end of the coupling nut 130. The coupling lock indicator 137 indicates a coupling lock with the mating receptacle connector 200.

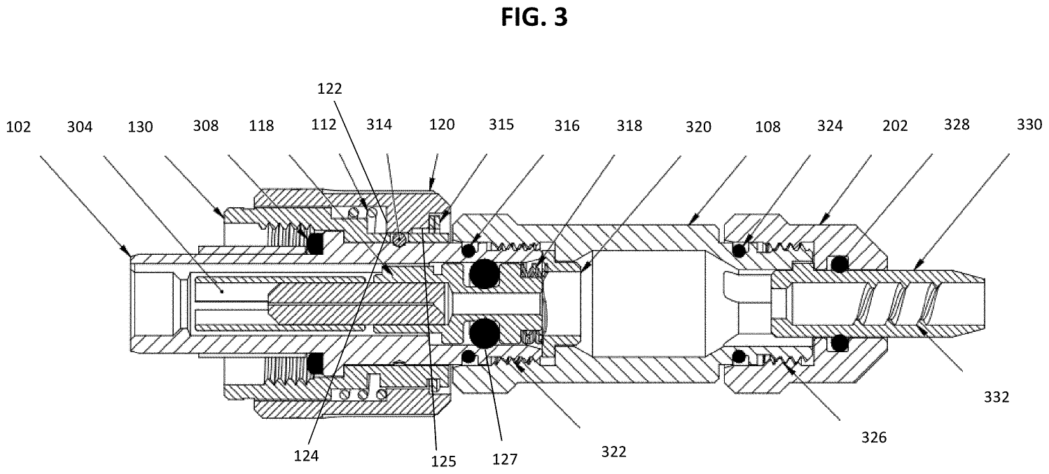

One or more retainer members 114 are positioned at the rearward end 134 of the inner coupling nut 130, defining recessed regions 115 therebetween. The retainer members 114 project outward from the outer surface of the rearward end 134 and can have transverse locking slots formed close to the rearmost distal end of the inner coupling nut 130. In addition, one or more circular openings 139 (three in the embodiment shown) are located about midway along the rearward end 134. The openings 139 extend completely through the rearward end 134 and are configured to retain a locking ball bearing 314. A shown in FIG. 3, the opening 139 and the ball bearing 314 are aligned with the channel 111 of the plug body 102 so that the ball bearing 314 can move into and out of respective ones of the indents 110, while remaining within the opening 139.

In certain embodiments, the inner coupling nut 130 is made out of a structurally acceptable metal. The outer coupling nut 120 has an inner bore that is larger than the inner coupling nut 130 to receive the inner coupling nut 130. The outer coupling nut 120 has one or more (three in the embodiment shown) lock guides 122 that project inwardly from an inner surface of the outer coupling nut 120 into the inner bore at the rearward end of the outer coupling nut 120. Each of the lock guides 122 aligns with a respective recessed region 115 at the rearward end 134 of the inner coupling nut 130. Accordingly, the lock guides 122 are slidably received in the respective recessed region 115. The lock guides 112 and retainer members 114 prevent the outer coupling nut 120 from rotating radially (i.e., transversely) with respect to the inner coupling nut 130, but allow the outer coupling nut 120 to slide forward and rearward with respect to the inner coupling nut 130.

As best shown in FIG. 3, the lock guides 122 have a step forming a locking portion 124 and an unlocking portion 125. The lock portion 124 extends further inward than the unlocking portion 125. The outer coupling nut has a locked position whereby the lock portion 124 is aligned with the ball bearing 314, the ball bearings are locked in a respective radial indentation, and the plug connector is locked to the mating receptacle connector. The outer coupling nut has an unlocked position whereby the unlocking portion 125 is aligned with the ball bearing 314, the ball bearings are free from the radial indentations, and the plug connector is unlocked from the mating receptacle connector.

The plug body 102 preferably has up to thirty radial indentations 110 that contain up to three ball bearings 314 that are substantially equally spaced, though any suitable number of indentations and ball bearings can be provided. As best shown in FIG. 3, the ball bearings 314 are received in the channel 111 in the outer surface of the plug body 102. The ball bearings 314 are retained in the openings 139 of the inner coupling nut 130 and held into the plug body 102 by the locking guide 122 of the outer coupling nut 120.

The spring 112 is positioned between the first step 135 of the inner coupling nut 130, and the forward face of the locking guide 122. The spring 112 is biased outward. In the default locked position, shown in FIGS. 3, 6A, the spring 112 pushes the outer coupling nut 120 outward (i.e., rearward or away from the inner coupling nut 130) with respect to the inner coupling nut 130. In that position, the locking portion 124 of the lock guide 122 is aligned with the ball bearing 314, which forces the ball 314 into the indent 110 and locks the inner coupling nut 130 to the plug body 102. Thus, in some embodiments, the plug body 102 is locked to the inner coupling nut 130 and the plug body 102 cannot be removed from the plug connector assembly 100.

To unlock the inner coupling nut 130 from the plug body 102, the user pushes the outer coupling nut 120 forward against the bias of the spring 112. The outer coupling nut 120 can move forward until the forward face of the locking guide 122 contacts the second step 136 of the inner coupling nut 130. When the outer coupling nut 120 moves forward with respect to the inner coupling nut 130, the unlocking portion 125 of the locking guide 122 is aligned with the ball bearing 314, as shown in FIG. 6B. In that unlocked position, the ball bearing 314 moves out of the indent 110, thereby unlocking the inner coupling nut 130 from the plug body 102, and the plug body 102 can be removed from the plug connector assembly 100.

Thus, the outer coupling nut 120 slides forward and rearward on the inner coupling nut 130 between a locked position and an unlocked position. In some embodiments, in the locked position, the plug body 102 is locked to the inner coupling nut 130 and the plug body 102 cannot be removed from the plug connector assembly 100. In that position, the outer coupling nut 120 is rearward with respect to the inner coupling nut 130, and the locking portion 124 forces the ball bearing 314 into one of the indents 110. In the unlocked position, the plug body 102 is unlocked from the plug connector assembly 100 and the plug body 102 can be inserted or removed from the plug connector assembly 100. In that position, the outer coupling nut 120 is forward with respect to the inner coupling nut 130, and the unlocking portion is aligned with the ball bearing 314 to allow the ball bearing 314 to escape the indents 110.

At this point, the outer coupling nut 120 is moved forward and the inner coupling nut 130 is unlocked. The user can then rotate the outer coupling nut 120. That, in turn, causes the inner coupling nut 130 to rotate because the lock guide 122 engages the retainer projections 114. The distal end of the inner coupling nut 130 is internally threaded. Thus, the inner and outer coupling nuts 120, 130 rotate together with respect to the plug body 102, such that the inner coupling nut 130 turns to threadably engage and disengage the threaded proximal outer surface of the receptacle body 210. Once the inner coupling nut 130 engages the receptacle body, the user releases the outer coupling nut 130. The spring 112 returns the outer coupling nut 130 to the locked position, thereby locking the outer coupling nut 130 to the inner coupling nut 120, and preventing further rotation of the inner coupling nut 120 with respect to the plug body 102 and receptacle body 210.

As further shown in FIG. 1, a ring receiving portion 123 is located at the rearward end of the outer coupling nut 120. The ring receiving portion 123 is adjacent the distal rear end of the outer coupling nut 120. The lock guide inward projections 122 are located adjacent to the ring receiving portion 123. The ring receiving portion 123 has a larger bore than the remainder of the outer coupling nut 120, such that a lip 126 is formed at the inward forwardmost side of the ring receiving portion 123.

A retaining ring 315 is received in the ring receiving portion 123 of the outer coupling nut 120. Referring to FIG. 3, the ring 315 is recessed within the distal rearward end of the outer coupling nut 120. In addition, the ring 315 is received in the transverse slot formed at the rearward end of the retainer projection 114 of the inner coupling nut 130. In operation, the plug body 102 is inserted into the inner coupling nut 130 and the inner coupling nut 130 is inserted into the outer coupling nut 120. The retainer ring 315 is then placed over the end of the inner coupling nut 130 and into the transverse slot. In that position, the retainer ring 315 locks the inner coupling nut 130 to the outer coupling nut 120. In the locked position, the retainer ring 315 is at the rearmost position and the outer coupling nut 120 is prevented from moving further rearward with respect to the inner coupling nut 130 by the lip 126. However, the outer coupling nut 120 can move forward to the unlocked position, which will cause the transverse slot and retaining ring 315 to move rearward in the ring receiving portion 123. Accordingly, the retaining ring 315 cooperates with the transverse slot and the lip 126 to lock the outer coupling nut 120 to the inner coupling nut 130, while at the same time allowing the outer coupling nut 120 to slide forward and rearward with respect to the inner coupling nut 130 so that the locking guide 122 can selectively lock and unlock the plug body 102 to the inner coupling nut 130. The inner coupling nut 130 preferably rotates, while the outer coupling nut 120 preferably slides fore and aft relative to the rest of the plug connector 100 (including relative to the inner coupling nut 130).

A wave spring 318 is located below the o-ring 316, just above the back shell washer 320. The o-ring 316 is located at a leading end of the back shell 108 and provides an environmental seal between the back shell 108 and the plug body 102 to protect against the environment, including to prevent dust and moisture from entering the plug connector 100 (including the back shell 108 and plug body 102). The o-ring 316 is preferably fabricated from silicone, but one of ordinary skill in the art will recognize that any acceptable material may be used. The back shell 108 mates to the threaded rearward end of the plug body 102, such that the back shell washer 320 and wave spring 318 ensure a secure fit between the back shell 108 and the plug body 102. The alignment sleeve 304 is used to provide alignment for the mating ferrules The back shell 108 is further secured by the threading 322 by which the back shell can be screwed onto the plug body 102.

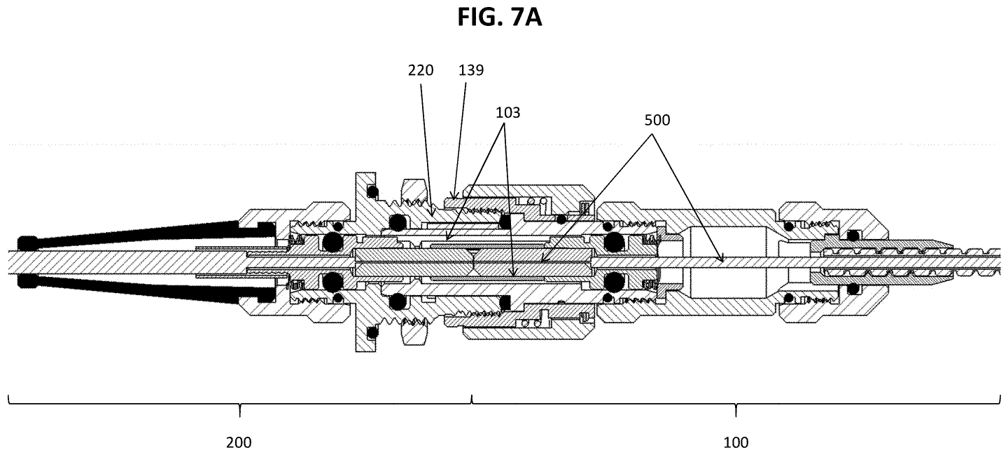

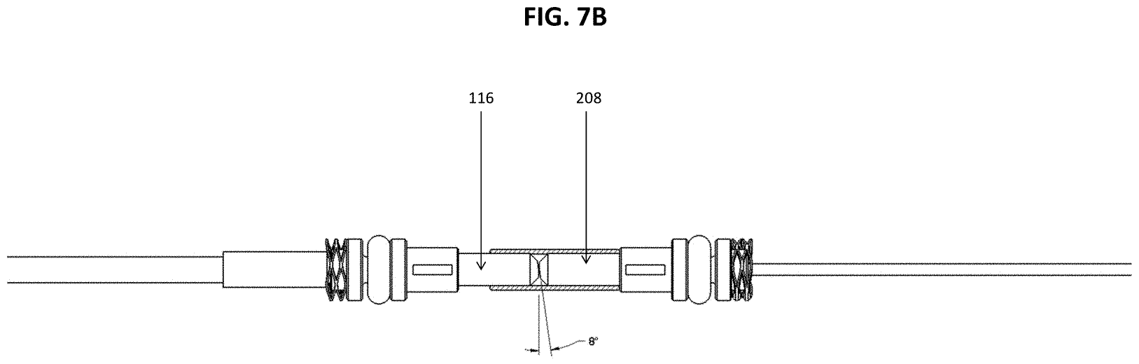

A ferrule 116 attached to a terminus 118 passes through substantially the center bore of the outer coupling nut 120. The terminus 118 of the ferrule 116 is oriented to pass into the and mate with the back shell 108 of the connector. In certain embodiments, the terminus 118 is polished with an 8° angle (other angles are sometimes used provided both connectors 100, 200 have matching angles) on the ferrule's 116 distal end face to reduce back-reflection of the optical signal which is detrimental in certain applications. Matching the position of the 8° angles between mating termini is useful to improve performance of the plug 100 and receptacle 200 connection (see FIG. 7B). A seal 127 can be located in a radial groove and provide a seal between the terminus 118 and the inner plug body 102.

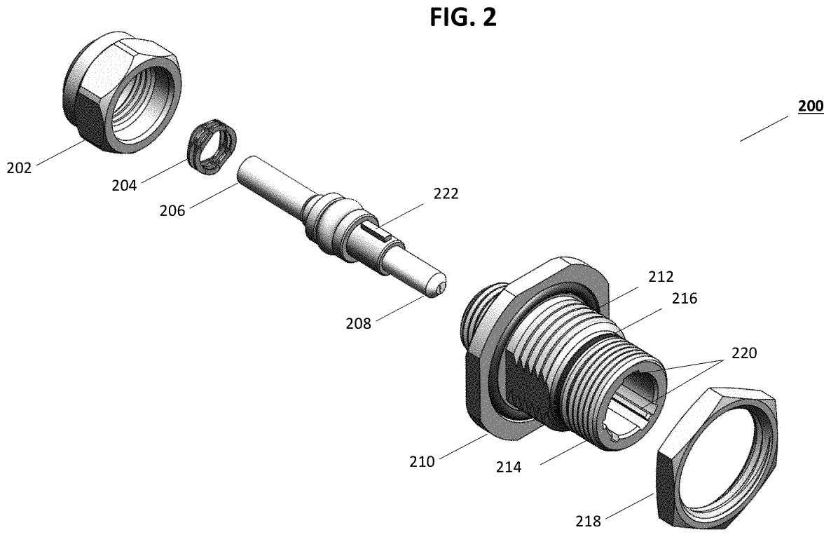

FIG. 2 is an exploded view of the mating receptacle connector 200. The mating receptacle connector 200 has a rear cap 202, spring 204, mating receptacle terminus 206, mating receptacle ferrule 208, and the receptacle body 210. The receptacle body 210 has a series of grooves 212 around which a jam nut 218 is designed to fit. In certain embodiments, there is a first set of proximal grooves 212 and a second set of distal grooves 214 that extend outward from the receptacle body 210. The second set of distal grooves 214 have a smaller diameter than the first set of proximal grooves 212. The receptacle body 210 also has a mating indicator 216. Typically, the mating indicator 216 is situated between the first set of proximal grooves 212 and a second set of distal grooves 214. The jam nut 218 is used to hold the mating receptacle connector 200 in place when mated to the plug connector 100. In certain embodiments, the jam nut 218 is replaced with such including structures such as a flange mount (with fasteners) as well as an inline (no panel).

In certain embodiments, the connector 100 has an external key 140 the projects outwardly from the outer surface of the leading portion of the plug body 102 in the longitudinal direction. The leading portion of the plug body 102 is slidably received into a corresponding inner bore of the receptacle body 200 (FIG. 2). The receptacle body inner bore has a mating groove 220 that extends longitudinally and aligns with the plug body external key 140. Thus, the plug body external key 140 is received in the receptable body groove 220 at the inner bore of the receptacle body 200. That provides a coarse alignment between the connectors 100, 200.

The terminus 118 body also has an external key 141 that extends along the longitudinal axis of the terminus body 118. And the receptacle terminus 206 has a body portion with a key 222 that projects outward from the outer surface of the body portion and extends along a longitudinal axis. In addition, the plug body 102 has an internal bore with a mating internal groove 103 (FIG. 7A) extending therethrough, and in one embodiment the groove 103 extends the entire length from a leading end of the plug body to the trailing end of the plug body 102. The terminus body external key 141 is slidably received into the corresponding internal grooves 103 of the plug body 102 at the trailing end of the plug body 102. And the external receptacle key 222 is slidably received into the corresponding internal grooves of the plug body 102 at the leading end of the plug body 102. The keys 141, 222 cooperate to provide further coarse alignment of the two terminus 206, 118. The 8° angle is polished onto the ferrule 116, 208 end-face relative to each of the respective external terminus key 141, 222. When mated, the internal groove in the plug body 102 engages the external termini key 141 of the plug body 102 and the external termini key 222 of the receptacle 200 connectors. Allowing both termini keys to fit within a shared or common groove 103 (i.e., each groove 103 extends the entire length of the body 102, so that each key 141, 222 engages the same groove, but at opposite ends of the body 102) minimizes misalignment due to manufacturing tolerances (i.e. size and positional) and improves performance. Thus, the connector 100 has keys on the mating termini that share a single feature to minimize the error caused by size and positional tolerances that accumulate from using multiple features.

The plug connector 100 herein is shown with a back shell and the mating receptacle connector 200 is shown with only the rear cap 202. The connectors 100, 200 are designed such that both the plug 100 and receptacle 200 are available with either configuration. The rear cap 202 version provides a shorter connection length and reduced mass, but at the expense of an environmental seal from the back of the connector. The back shell 108 configuration is fully sealed (by the o-rings 316, 324 at the leading and trailing ends of the back shell 108, as well as by the o-ring 328 at the rear cap 328) to prevent dust and/or moisture from entering the connector 100. A fiber 500 (FIG. 7A) passes through the plug connector 100 and the mating receptacle connector 200.

FIG. 3 shows a side cross-sectional view of the plug connector 100 and portions of the mating receptacle connector 200 in accordance with an embodiment of the disclosure. The plug body 102, which is also shown with reference to FIG. 1, is configured to enclose the alignment sleeve 304. The alignment sleeve 304 is designed to ensure proper orientation and alignment of the ferrule 116. The inner coupling nut 130 is positioned over the plug body when the plug connector 100 is assembled. The inner coupling nut 130 is capable of mating and locking to the outer coupling nut 120. The plug body 102 has a groove 103 in the top half, as shown with reference to FIG. 7A. That is the common groove 103 that both the plug 100 and mating receptacle 200 and terminus 118, 206 fit to align the 8° angles of the ferrule end faces. As explained above, a fiber 500, shown with reference to FIG. 7A, passes through the plug connector 100 and the mating receptacle connector 200. In certain embodiments, the fiber has a narrower diameter where it passes through the common groove 103 and a greater diameter where it passes through the rest of the plug connector 100 and the mating receptacle connector 200.

The cushion seal 308 is situated on the plug body 102 between the plug body 102 and the inner coupling nut 130. The seal 308 is located in a groove between the key 140 and the forward-facing lip of the plug body 102. In certain embodiments, the inner coupling nut 130 has ⅜-40 thread to engage a matching thread on the receptacle 200. If thirty indentations 110 are present, in combination with the ⅜-40 thread, the connector 100 permits only 0.0008 inches of linear travel between the connectors 100, 200 before locking in the next position, or approximately to lock every 12 degrees of rotation. The front distal end of the receptacle body 210 contacts the cushion seal 308 when the receptacle body 210 is threadably connected to the inner nut 130 (FIG. 7A). The cushion seal 308 is designed to compress and take on any slack in the connection.

The opposite side of the back shell 108 is comprised of another o-ring 324. The o-ring 324 is preferably fabricated from silicone, but one of ordinary skill in the art will recognize that any acceptable material may be used. The o-ring 324 is used along with the threading 326 to provide an environmental seal for the rear cap 202 of the mating receptacle connector 200 (also shown in FIG. 2) to the back shell 108. Yet another o-ring 328 is used to hold the rear cap 202 in place against the conduit adapter 330. The o-ring 324 is located between the rear cap 202 and the back shell 108, and the o-ring 328 is located between the cap 202 and the adapter 330. The o-rings 324, 328 protect against the environment, including to prevent dust and moisture from entering the plug connector 100 (including the plug body 102 and the back shell 108). The conduit adapter 330, as well as one or more cable adapters 332, twist and drop through the back shell 108 to assist in the assembly of the system and to ensure that the fiber length is optimal without excessive bending due to extra length. The back shell 108 is shown in FIG. 3 with the conduit adapter 330, but may be used in other configurations known to those with ordinary skill in the art to attach the connector 100 directly to fiber optics cables of varying diameters.

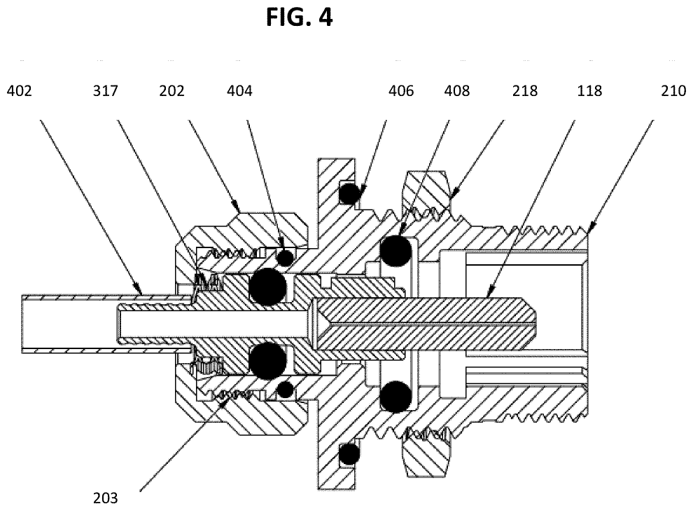

Referring to FIG. 4, a cross-sectional view of the locking mechanism of the mating receptacle connector 200 is shown mated to the plug connector 100. From left to right, the crimp sleeve 402 is shown as fitting through wave spring 317. The rear cap 202 has internal threads 203 and fits over the top of the crimp sleeve 402 and a secure fit is ensured by the o-ring 404. An o-ring 403 is located between the terminus and the receptacle body 202. The jam nut 218 is used to hold the mating receptacle connector 200 in place. The o-ring 408 may be used to provide an environmental seal between the receptacle body 210 and the plug body 102 of the plug connector 100 (see FIG. 7A). The receptacle body 210 is comprised of a series of grooves 212 around which a jam nut 218 is designed to fit. The o-rings 403, 404, 406, 408 are designed to provide secure fits and an environmental seal for the components, for instance so that dust and moisture does not enter the receptacle body 210 or the plug connector 100. FIG. 7A further illustrates all of the seals 403, 404, 406, 408, 308, 316, 127, 324, 328 positioned between various components of the receptacle 200 and plug connector 100. Those seals ensure reliable fits between the components and protect against the environment including to prevent dust and moisture from entering the receptacle 200 and/or plug connector 100 and/or to prevent dust and moisture from travelling within the receptacle 200 and/or plug connector 100.

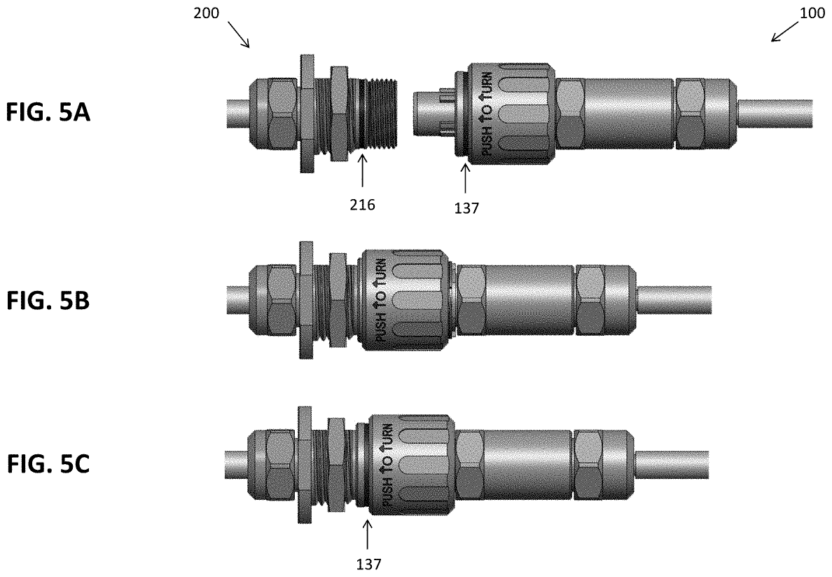

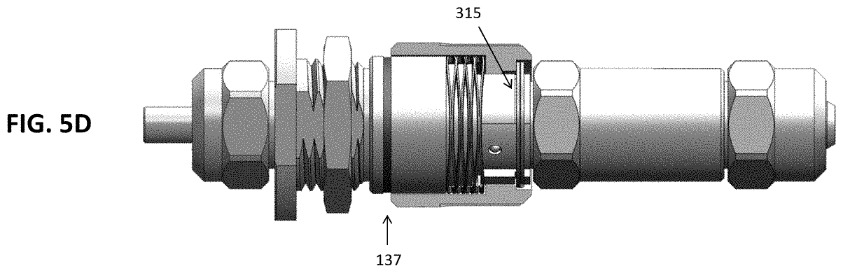

FIGS. 5A-5C show an exemplary operation by which the system achieves mating and coupling. Coupling occurs between the plug connector 100 of FIG. 1, and the mating receptacle connector 200 of FIG. 2. In FIG. 5A, the plug connector 100 is uncoupled from the mating receptacle connector 200. In that configuration, the plug connector 100 is brought together with the mating receptacle connector 200 such that the plug body 102 is aligned substantially parallel with the receptacle body 210 of the mating receptacle connector 200. The plug body 102 is configured to slide into the receptacle body 210. Both the mating indicator 216 and the coupling lock indicator 137 are visible in this uncoupled configuration.

FIG. 5B is a diagram of the plug connector and the mating receptacle connector in a fully coupled, unlocked orientation. As shown this configuration, the plug body 102 and the mating receptacle connector 200 are mated together, with the receptacle body 210 threadably coupled with the inner coupling nut 130 to be fully mated with the inner coupling nut 130. In this configuration, neither the mating indicator 216 nor the coupling lock indicator 137 are visible, which indicates that the system has been fully mated, but has not yet been locked.

FIGS. 5C, 5D show the plug connector 100 and the mating receptacle connector 200 in a fully coupled, locked orientation. As shown in this configuration, the plug body 102 and the rear cap 202 are fully mated and only the coupling lock indicator 137 is visible. The visibility of the coupling lock indicator 137 provides an unambiguous indication that the plug connector 100 and the mating receptacle connector 200 are fully mated, locked, and ready for use. Thus, the coupling lock indicator 137 is positioned on the inner coupling nut 130 to be exposed when the outer coupling nut 120 is in the locked position (FIGS. 5C, 5D), and covered by the outer coupling nut 120 when the outer coupling nut 120 is in the unlocked position (FIG. 5B).

It will be apparent to those skilled in the art having the benefit of the teachings presented in the foregoing descriptions and the associated drawings that modifications, combinations, sub-combinations, and variations can be made without departing from the spirit or scope of this disclosure. Likewise, the various examples described may be used individually or in combination with other examples. For example, the use of an alignment mechanism (i.e., the common groove 103 used to align the two terminus bodies 118, 206) is shown used in combination with a locking mechanism (e.g., the ball bearings 314 being locked in the indentations 110 by the outer coupling nut 120). However, the alignment mechanism can be utilized by itself, e.g., without a locking mechanism or with any suitable locking mechanism other than the one shown in the example embodiments. In addition, the locking mechanism can be utilized by itself, e.g., without an alignment mechanism or with any suitable alignment mechanism other than the one shown in the example embodiments. Those skilled in the art will appreciate various combinations of examples not specifically described or illustrated herein that are still within the scope of this disclosure. In this respect, it is to be understood that the disclosure is not limited to the specific examples set forth and the examples of the disclosure are intended to be illustrative, not limiting.

As used in this specification and the appended claims, the singular forms “a”, “an” and “the” include plural referents, unless the context clearly dictates otherwise. Similarly, the adjective “another,” when used to introduce an element, is intended to mean one or more elements. The terms “comprising,” “including,” “having” and similar terms are intended to be inclusive such that there may be additional elements other than the listed elements.

It is noted that the description and claims may use geometric or relational terms, such as rearward, forward, leading, trailing, distal, proximal, right, left, above, below, spherical, semi-spherical, curved, bottom, linear, radially, elongated, parallel, transverse, etc. These terms are not intended to limit the disclosure and, in general, are used for convenience to facilitate the description based on the examples shown in the figures. In addition, the geometric or relational terms may not be exact, for example, due to roughness of surfaces, tolerances allowed in manufacturing, etc.

1. A connector assembly comprising:
a plug connector having a plug body, a first external key, an inner coupling nut, an outer coupling nut, a back shell, and a first ferrule, wherein the plug body is comprised of an internal groove; and
a mating receptacle connector having a rear cap, a receptacle body, a corresponding groove, a second external key, and a second ferrule;
wherein the external key mates to the corresponding groove, wherein the internal groove of the plug body engages the first external key of the plug connector and the second external key of the mating receptacle connector, resulting in alignment of the first ferrule with the second ferrule.

2. The connector assembly of claim 1, wherein the first ferrule is aligned with the second ferrule with an 8° angle on the first ferrule's endface and an 8° angle on the second ferrule's endface.
